(19) United States
(12) Patent Application Publication
(10) Pub. No.: US 2004/0112282 A1
(43) Pub. Date: Jun. 17, 2004

(54) Device for suctioning an air boundary layer from a running web of material

(76) Inventors: Rolf Metzger, Dietlikon (CH); Luca Frediani, Zurich (CH); Bruno Holtmann, Dielsdorf (CH); Hans Hardegger, Greifensee (CH)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/474,789

(22) PCT Filed: Apr. 5, 2002
(86) PCT No.: PCT/EP02/03775

(30) Foreign Application Priority Data
Apr. 9, 2001 (DE) 101 17 667.8

(51) Int. Cl. B05C 5/00; B05C 15/00

(52) U.S. Cl. 118/50; 118/300

(57) ABSTRACT

In order to suction the air boundary layer from a running web of material (1) before coating with a curtain-coater, a suction box (8) is arranged in the area of a roller (4) deflecting the web of material (1), said suction box having the following characteristics: a) the suction box (8) extends in its breadth along the axial length of the deflection roller (4); it is open towards the deflection roller (4) and attached to a suction blower, b) it has a corresponding seal (10, 11) on the inlet and the outlet sides, which form a gap (12, 13) with the web (1) and extend along the axial length of the deflection roller (4), wherein at least the end of the seal (10) on the inlet side and the beginning of the seal (11) on the outlet side are located on the deflection roller (4) in the deflection area of the web (1); c) the suction box (8) has a front-face seal (14) on each of the front faces of the deflection roller (4), which extend outside adjacent to the seal of the front face, parallel thereto and at a close distance thereof; d) the seal (11) on the outlet side forms an outlet gap (13) with the web (1), whose height and length measured in the direction of advancement of the web are substantially constant along the entire width of the suction box (8), wherein the length is longer than 10 mm, preferably longer than 30 mm, especially 50 mm-70 mm, and the height of the gap is selected depending on the speed of the web in such a way that the value of the product web speed (m/min)×gap height (in mm) is less than 1500.

### FIELD OF THE INVENTION

The invention relates to an apparatus for suctionally stripping the boundary air layer off a web deflected over a roll as well as to a system for coating a traveling web that is provide with such a stripping apparatus.

### STATE OF THE ART

A traveling web, such as of paper or cardboard, plastic or metal foil, is coated by a so-called curtain coater which applies the coating material (glue dispersion, ink, etc) as a curtain dropping from a slot nozzle onto the web. In order for the curtain coater to form a uniform coating it is essential that the curtain dropping from the slot nozzle be stable, not move, and not form bubbles on the web. Thus the boundary air layer that forms on the web at high web-travel speeds of more than 400 m/min creates problems. The boundary air layer adhering to the web creates irregular disturbances in the curtain and makes bubbles that create irregularities in the coating thickness.

A curtain coater in EP 0,489,978 for creating photographic materials has upstream of the slot nozzle a shield-like element (“air shield”) which serves for stripping off the boundary air layer. The element is positioned near a deflecting roll for the web and extends in an arc over a predetermined angular portion of the deflecting roll. The element is constructed such that its upstream edge and downstream edge form zones in which the wind resistance is greater than in the zone between the two end regions. In the zone between the zones of greater wind resistance there is a chamber that is connected to a suction line to reduce its pressure. The spacing between the seal-like elements at the upstream and downstream edges and the deflecting roll is between 0,5 mm and 2 mm. The spacing between the downstream edge of the shield-like element and the curtain is between 5 mm and 30 mm.

### SUMMARY OF THE INVENTION

It is an object of the invention to provide an apparatus that makes it possible to reduce the boundary air layer on a wide (2 m and more) web at high web-travel speed (1000 m/min and more) such that a curtain coater provided downstream applies the coating material uniformly.

This object is attained in that a suction box is provided at the deflecting roll and has the following features:

The suction box extends a full axial length of the deflecting roll, is open toward the deflecting roll, and is connected to the intake of a fan;

It has upstream and downstream seals (10 and 11) that form respective gaps (12 and 13) with the web and extend the full axial length of the deflecting roll, at least the downstream edge of the upstream seal and the upstream edge of the downstream seal being positioned where the web is deflected around the deflecting roll;

The suction box has at each axial end face of the deflecting roll an end seal that is parallel to and extremely closely spaced from the respective end face;

The downstream seal forms with the web a downstream gap whose height and width measured in the web travel direction are generally constant over the entire length of the suction box, this width being more than 10 mm, preferably more than 30 mm and in particular 50 mm-70 mm and the gap having a dimension selected depending on the web travel speed such that the product of the web-travel speed (m/min)×gap width (in mm) is less than 1500.

According to the invention instead of the “air shield” there is a suction box that suctionally strips off the boundary air layer. It has been determined that the effectiveness is highly dependent on the shape and orientation of the downstream seal. They are set in accordance with the web-travel speed such that the boundary air layer on the web and at the ends of the deflecting roll is largely eliminated downstream of the seal. the curtain of of coating material of a curtain coater provided in this region is thus not disturbed.

### BRIEF DESCRIPTION OF THE DRAWING

In the following the invention is more closely described with reference to embodiments that are schematically shown in the drawing, wherein:

FIG. 1 is a side view of a curtain-type coating system where the slit nozzle is set so that the curtain falls on an apex line of a deflecting roll supporting the web;

FIG. 2 is a large-scale view of the apparatus for suctioning off the air boundary layer;

FIG. 3 is a curtain-type coating system where the curtain of coating material falls on the web downstream of the deflecting roll;

FIG. 4 is the suctioning apparatus for the curtain coater of FIG. 3 in enlarged scale.

### WAYS OF CARRYING OUT THE INVENTION

The coating system shown in the drawing serves for applying a dispersion-type adhesive (e.g. an acrylate) in an aqueous solution to a siliconized paper web 1. As a result of its advantageous features the system can also serve for applying other dispersions to paper, plastic foils, or thin strips or to coat paper or cardboard webs with ink.

The coating system has a slot nozzle 2 that is suspended above the path of the web 1 in a frame. The slot nozzle 2 is connected to a supply of coating material and has on its lower side an outlet slot from which the coating material passes as a free-falling curtain 3 that lands on the web surface. The width of the slot nozzle is greater than the width of the web 1 being coated.

Upstream of the slot nozzle 2 the web 1 passes around a deflecting roll 4 whose axial length extends over the entire working width of the coating system, that is the maximum width of a web 1 that can be coated.

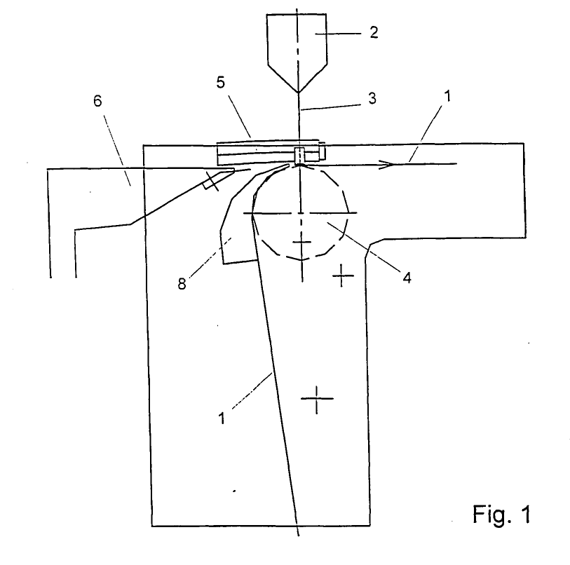

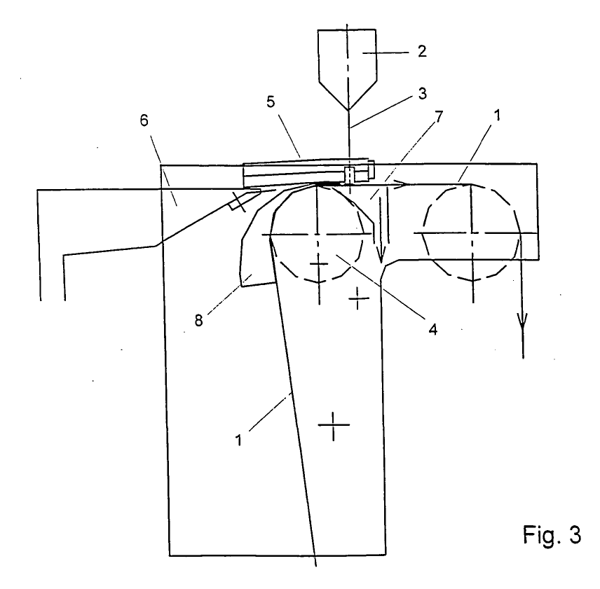

At both axial ends of the coating system underneath the slot nozzle 2 are edge troughs 5 that limit the curtain 3 to the desired coating width. The edge troughs are both hung from the frame of the nozzle 2 so that move in or against the web-travel direction with the nozzle 2. The edge troughs 5 catch the coating material at the curtain ends and conduct it to a collection pan 6. The collection pan 6 is provided immediately upstream of the deflecting roll 4. When the coating process is started the slot nozzle 2 and the parts carried on it are moved above the collection pan 6. Then at first a stable curtain 3 is produced that drops into the collection pan 6. Subsequently the slot nozzle 2 is moved into its working position above the deflecting roll 4 (FIG. 1) or somewhat downstream therefrom (FIG. 3).

The embodiment of FIG. 1 serves to apply a coating with a width smaller than the web width. Thus the coated web 1 has coating-free edges. In the embodiment according to FIG. 3 the web 1 is coated over its entire width. The curtain is therefore wider than the web 1. The slot nozzle 2 in its working position is downstream of the apex line of the deflecting roll 4 so that a pan 7 can be positioned underneath the curtain 3 to catch the coating material falling past the web edges. The web 1 is fed horizontally to the region underneath the slot nozzle 2 and then is deflected downward over a second deflecting roll 8.

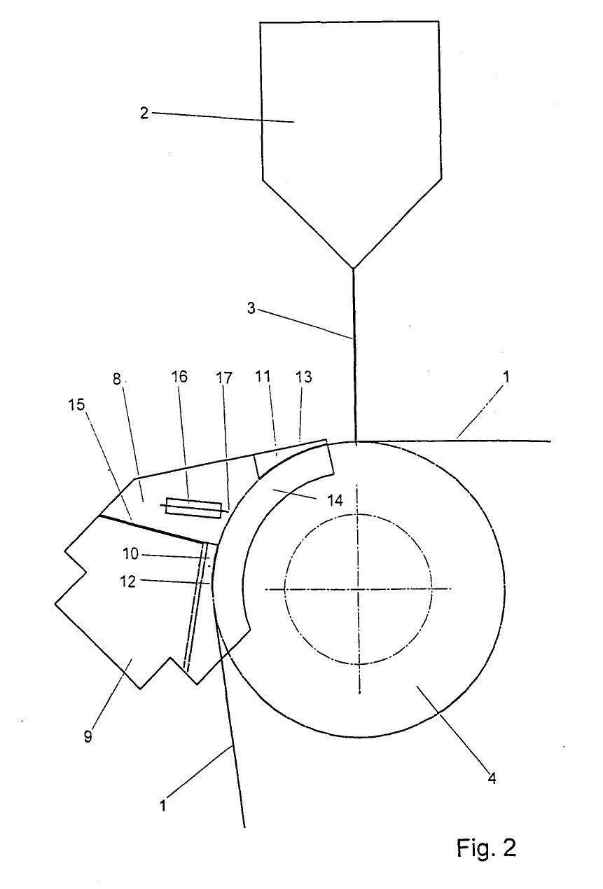

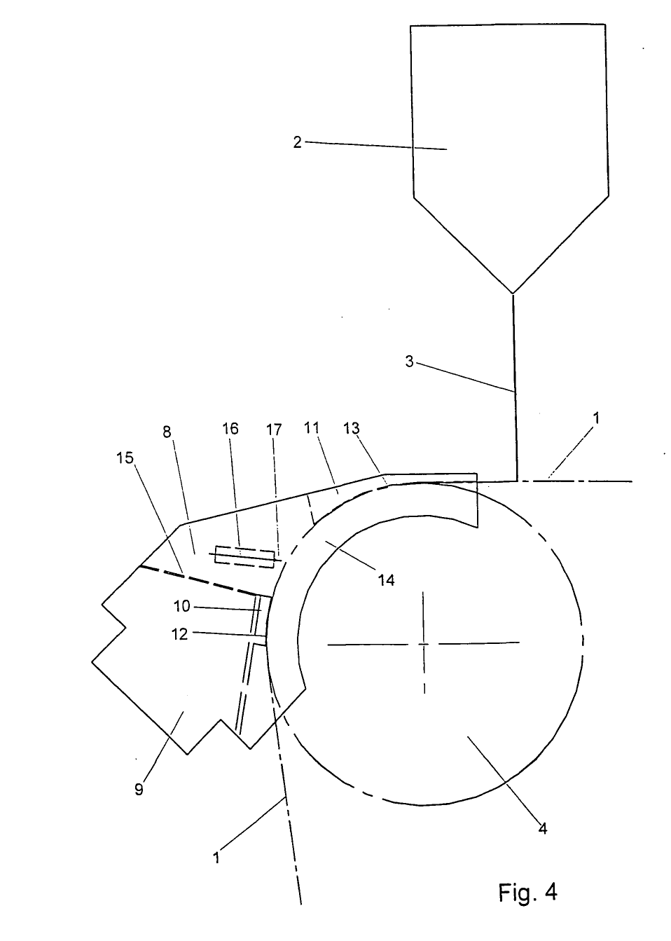

In order to suctionally strip the air boundary layer off the web 1 and the edges of the deflecting roll 4 there is a vacuum apparatus spaced upstream in the web-travel direction from the slot nozzle 2 as shown in large scale in FIGS. 2 and 4.

A suction box 8 in the deflection region of the deflecting roll 4 is open toward the deflecting roll 4, to the web 1, and is connected via a suction line 9 in its rear wall to the intake of a fan. The suction box 8 is long enough to extend over the entire axial length of the deflecting roll 4. It has on its upstream side an upstream seal 10 and on its downstream side a downstream seal 11 that each extend over the full axial length of the deflecting roll 4 and form respective gaps 12 and 13 with the web 1. At least the downstream edge of the upstream seal 12 and the upstream edge of the downstream seal 13 are positioned in the region where the web 1 is deflected by the deflecting roll 4. At each end of the deflecting roll 4 the suction box 8 has an end seal 14 that extends externally parallel at a very close spacing with the end face. For sufficient sealing at the end faces the seal elements 14 have lengths measured radially of the deflecting roll or at least 10 mm, preferably more than 15 mm, at the ends of the deflecting roll 4.

The downstream seal 11 is so constructed and arranged that it forms with the web 1 the downstream gap 13 whose width measured parallel to the web travel direction and height are generally constant over the entire width of the suction box, that is over the entire axial length of the deflecting roll 4. The width of the downstream gap 13 is more than 10 mm, preferably more than 30 mm and in particular 50 mm to 70 mm. The height of the downstream gap 13 is set according to the web travel speed such that the value of the product of web speed (in m/min)×gap height (in mm) is smaller than 1500. With a web travel speed of 1000 m/min the gap height is thus less than 1.5 mm.

The distance along the roll surface between the downstream edge of the upstream seal 10 and the upstream edge of the downstream seal 11 is more than 10 mm, preferably 50 mm-500 mm. In this region the boundary air layer is suctioned off the web 1 by the subatmospheric pressure in the suction box 8. It has been seen that the vacuuming is improved when the upstream seal 10 and the downstream seal 11 are constructed such that they have sharp edges at their respective upstream and downstream edges. At least the downstream seal 11 is thus sharp at its upstream and downstream edges, and preferably the upstream seal 10 has at least at its downstream edge a similar sharp edge.

For uniform distribution of the subatmospheric pressure in the suction box 8, it has at least one partition wall 15 formed with a uniform array of holes and extending the full width of the suction box 8. Preferably the partition 15 is formed by a perforated plate that subdivides the suction box 8 into a rear compartment having the suction line 9 and a front compartment that is open toward the web 1. The partition 15 also serves to rigidify the structure of the suction box 8.

In order to better strip the air boundary layer the suction box 8 is provided with a corona-discharge electrode 16 that is connected to a high-voltage source. Such a corona-discharge electrode and its use in separating gaseous laminar boundary layers are described in detail in EP 0,837,824. The deflecting roll 4, which is grounded and formed of a conductive material, typically metal, forms a counter electrode on the opposite web side. The discharge electrode 16 extends over the full width of the suction box 8 and has a row of parallel points 17 directed at the web 1. The applied high voltage causes the points 17 of the discharge electrode 16 to emit electrons or positrons that create turbulence in the boundary air layer and thus cause it to spin off. The points 17 are spaced as closely as possible from the web, with a spacing from the web 1 of 0.1 mm-10 mm, preferably 1 mm-5 mm. The spacing transverse to the web between adjacent points 17 is about 5 mm.

In the coating systems shown in FIGS. 1 and 3 the suction box 8 is positioned such that the distance from the downstream edge of the downstream seal 11 to the curtain 3 produced by the slot nozzle 2 is 10 mm-200 mm, preferably 20 mm-70 mm. Such a spacing not only ensures that no new boundary air layer can form that would disturb the curtain 3, but also prevents disturbances of the curtain 3 by sucking in air through the downstream gap 13. In order that in the coating system according to FIG. 3 the small distance from the downstream seal 11 to the curtain 3 can be maintained, the suction box 8 used there and in FIG. 4 is extended at its downstream end. The downstream end of the suction box 8 with the downstream seal extends substantially past the apex line of the deflecting roll 4.

Advantageously the upper wall of the suction box 8 is constructed such that it only projects slightly above the periphery of the deflecting roll 4. This makes it possible to mount the edge troughs 5 above the suction box and directly above the web path so that they can be inclined downward opposite the web-travel direction so that the caught coating material runs into the pan 6. Preferably the suction box 8 can be pivoted away from the deflecting roll 4 so that a new web can be loaded into the coating system. In addition in this manner the front side open toward the web 1 is made accessible for servicing.

1. An apparatus for stripping a boundary-air layer off a traveling web (1) deflected around a roll (4) with a suction box (8) provided at the deflecting roll (4) and having the following features:
a) the suction box (8) extends a full axial length of the deflecting roll (4), is open toward the deflecting roll (4), and is connected to the intake of a fan;
b) it has upstream and downstream seals (10 and 11) that form respective gaps (12 and 13) with the web (1) and extend the full axial length of the deflecting roll (4), at least the downstream edge of the upstream seal (10) and the upstream edge of the downstream seal (11) being positioned where the web (1) is deflected around the deflecting roll (4);
c) the suction box (8) has at each axial end face of the deflecting roll (4) an end seal that is parallel to and extremely closely spaced from the respective end face;
d) the downstream seal (11) forms with the web (1) a downstream gap (13) whose height and width measured in the web travel direction are generally constant over the entire length of the suction box (8), this width being more than 10 mm, preferably more than 30 mm and in particular 50 mm-70 mm and the gap having a dimension selected depending on the web travel speed such that the product of the web-travel speed (m/min)×gap width (in mm) is less than 1500.

2. The apparatus according to claim 1, characterized in that, measured along the roll surface, the downstream edge of the upstream seal (10) is spaced from the upstream edge of the downstream seal (11) by more than 10 mm, preferably 50 mm-500 mm.

3. The apparatus according to claim 1 or 2, characterized in that the end seals (14) overlap the end faces of the deflecting roll (4) by a distance measured radially of the deflecting roll (4) of at least 10 mm, preferably more than 15 mm.

4. The apparatus according to one of claims 1 to 3, characterized in that the downstream seal (11) is sharp at its upstream and downstream edges.

5. The apparatus according to one of claims 1 to 4, characterized in that inside the suction chamber (8) there is a transverse partition (15) formed with holes and forming a rear compartment with the suction line (9) and a front compartment open toward the web (1).

6. The apparatus according to one of claims 1 to 5, characterized in that the suction box (8) can be pivoted away from the deflecting roll (4).

7. The apparatus according to one of claims 1 to 6, characterized in that the suction box (8) holds a corona-discharge electrode (16) with a row of parallel points directed toward the web (1) and connected to a high-voltage source.

8. The apparatus according to claim 7, characterized in that the points (17) of the electrode (16) are spaced 0.1 mm-10 mm, preferably 1 mm-5 mm, from the web (1).

9. A system for coating a traveling web (1) with a slot nozzle (2) from which a curtain (3) of the coating material drops and upstream from the slot nozzle (2) an apparatus for stripping a boundary air layer off the web (1), characterized in that an apparatus according to one of claims 1 to 8 is provided upstream in the web-travel direction from the slot nozzle (2).

10. The apparatus according to claim 9, characterized in that the suction box (8) is positioned such that the downstream edge of the downstream seal (1) is spaced 10 mm-200 mm, preferably 20 mm-70 mm, from the curtain (3) dropping from the slot nozzle (2).
